(19) United States
(12) Patent Application Publication
(10) Pub. No.: US 2014/0260153 A1
(43) Pub. Date: Sep. 18, 2014

(54) Mower Head with Continuous Cutting Blade Loop

(71) Applicants: Basil Eric Blank, Ithaca, NY (US); Charles P. Henderson, Ithaca, NY (US)

(72) Inventors: Basil Eric Blank, Ithaca, NY (US); Charles P. Henderson, Ithaca, NY (US)

(21) Appl. No.: 13/795,617

(22) Filed: Mar. 12, 2013

(51) Int. Cl. A01D 34/83

(52) U.S. Cl. CPC A01D 34/831
USPC 56/14.7; 56/16.7

(57) ABSTRACT

A mower having a mowing head with a stationary horizontal comb and a continuous cutting blade loop slidingly positioned against the bottom surface of the comb, both having teeth arranged to accept and then shear off plant material between them at a user defined height above the ground. The teeth in the continuous cutting blade loop move past the teeth in the comb, powered by one or more drive guide pulleys transferring motive power to the blade from an external source, are mounted.

### BACKGROUND OF THE INVENTION

1. Field of the Invention

The invention pertains to the field of mowers. More particularly, the invention pertains to a mower having a continuous cutting blade loop.

2. Description of Related Art

Lawn mowers have been in production and use since the early part of the 19^{th} century, and have been developed in three distinct basic configurations: reel mowers, rotary mowers, and sickle bar mowers. The advantages and drawbacks of the three configurations are described herein.

The first reel mower was designed in 1827 by Edwin Budding and granted a British Patent in 1830, and a later US Patent to Passmore (1879, Reissue Number 8,560). The fundamental reel mower concept concept, one that is still in use today, relied on three major components: a cutting cylinder or reel, a stationary bed knife, and a frame upon which all cutting components and carriage could be mounted. The cutting cylinder, or reel, comprised a multitude of helical knifes arranged to form an open cutting cylinder. The cutting cylinder in turn was mounted on a longitudinal axle that received motive force from the carriage wheels when the mower was pushed, causing it to rotate. At the lower side of the cutting cylinder, a stationary bed knife was positioned to be in close proximity to the rotating helical knives such that plant material would be swept into the cutting cylinder as it rotated and the mower moved forward, and then sheared between the rotating helical knives and the stationary bed knife. Gearing between the carriage wheels, whether through actual gears or by means of a drive chain connection, ensured that the cutting cylinder would rotate at sufficiently high RPM when the mower was pushed by human power along the cutting pathway. Since that time, this basic configuration has been embodied in many forms ranging from push mowers for domestic use, to large ganged sets of mowers towed behind tractors for large mowing operations, e.g., golf course fairways.

Reel mowers are characterized by a clean uniform shearing cut at the height of the bed knife which is advantageous for the health and recovery of the plant material being cut. While this arrangement is well suited to human powered configurations and has been adapted to self powered systems using internal combustion engines, maintenance of the mower by the user is cumbersome. The helical blades of the cutting cylinder are not removable and require special tooling to be sharpened, and the stationary bed knife must be removed for sharpening and replaced with proper tolerances between its cutting edge and the pathway of the rotating cylinder helical knives for optimal operation.

Rotary mowers were first introduced in the 1920's. In this configuration a planer knife is positioned in the horizontal plane and rotated via a vertical shaft through its center of mass, being sharpened on the leading edge of this rotation on each end for at least part of its length. As the knife rotates about its axis, the sharpened ends impact the plant material being cut, and cuts it off. The cuts produced by rotary mowers tend to be less uniform than those of reel mowers, also resulting in more trauma to the plant material.

Due to their high rotational speed, rotary mowers are also enclosed in decks that serve as a mounting frame with a shroud extending downward around the cutting knife for safety, the clippings being either mulched by the rotating blade, or expelled at high speed through a port in the protective shroud. Rotary configurations, while extremely popular, have some drawbacks in addition to the less preferred cutting characteristics previously mentioned.

As the cutting blade is primarily surrounded by a safety shroud, rotary motors are not well suited for cutting long grass or weeds in general, as the portion of the safety shroud in the direction of the cutting pathway impacts tall plant material causing resistance to forward movement. Further, the containment of the cuttings under the deck by the shroud can cause the rotary knife to bog down in extreme examples, slowing to a point of not being able to effectively cut, or stopping. More recently, high torque electric motors have been added to provide motive force to the rotating blade, but must rely on lengthy cords for electrical power, or batteries with relatively limited lifetime and long charge periods in between. Removal of the blade on rotary mowers for sharpening is also a relatively involved process requiring tools.

The third category is the sickle bar mower. A stationary sickle bar, or comb, having teeth extending radially from its leading edge and separated by a gap between adjacent teeth, directs plant material against the back of each gap. An oscillating cutting bar, slidingly positioned in contact with the lower surface of the stationary comb, also has mating teeth in its leading edge that alternatively cause the gap between the comb teeth to open, allowing plant material to enter the gap, then close laterally, causing a shearing action at the edge of the stationary teeth and oscillating teeth, thus cutting the plant material. Sickle bar mowers have found primary applications in agricultural use as their shear cut on plant material has advantages similar to those produced with reel mowers, and they can be constructed to be mounted in various positions such as at the front of a tractor, or as outriggers for mowing difficult regions around ditches or embankments when the sickle bar is raised or lowered at some angle relative to the horizontal. Further, because of free access above and in front of the sickle bar, they are well suited to mowing tall plants and even light brush, with the clippings falling uniformly behind the sickle bar.

However, sickle bar mowers have been limited to receiving motive force from internal combustion sources as the reciprocal nature of the cutting blade requires translation of rotational motion (from an engine or motor shaft, or tractor power take-off unit) into reciprocating motion of the blade. Such a translation is inefficient as it requires the blade to decelerate, stop, and accelerate in the opposite direction during each reciprocating cycle. As such they have been difficult to implement in a human powered form for domestic lawn maintenance.

### SUMMARY OF THE INVENTION

The present invention integrates advantageous shearing cut characteristics in a mowing head that also provides efficient motive power requirements and ease of blade replacement. The mowing head of the mower has a stationary horizontal comb and a continuous cutting blade loop slidingly positioned against the bottom surface of the comb, both having teeth arranged to accept and then shear off plant material between them at a user defined height above the ground. The teeth in the continuous cutting blade loop move past the teeth in the comb, powered by one or more drive guide pulleys transferring motive power to the blade from an external source, are mounted.

A cutting apparatus is discussed below that is advantageous to the health of plant material being cut, as well as an energy efficient mechanical system that is suited to human power by taking motive force from the wheels of a carriage being pushed by a human. Alternatively, the sickle bar mowing head may efficiently receive drive guide pulley motive force from a small electric motor or internal combustion engine.

### BRIEF DESCRIPTION OF THE DRAWING

FIG. 1 shows a schematic of one exemplary embodiment of the sickle bar mower head using a walk-behind human powered carriage.

FIG. 2 shows a schematic of one exemplary embodiment of the sickle bar mower head used with a walk-behind human powered carriage.

FIG. 3A shows a detailed perspective view of one exemplary embodiment of the sickle bar mower head incorporating a continuous cutting blade loop, blade tensioner, and comb.

FIG. 3B shows a frontal view of one exemplary embodiment of the sickle bar mower head in which an additional free wheel guide pulley is used in conjunction with a blade tensioner spring.

FIG. 3C shows a side view of a free wheel guide pulley incorporating both a tensioner spring and a tracking adjustment that allows the angle of the free wheel guide pulley axle to be changed relative to the plane of the chassis.

FIG. 4A shows the generalized comb-blade combination and comb-blade tooth spacing relationship.

FIG. 4B shows a profile cut through a two piece comb having an upper half and a lower half machined to form a slot for the continuous cutting blade loop.

FIG. 4C shows a profile cut through of a one piece comb having retaining wheels at its trailing edge to hold the continuous cutting blade loop against the lower surface of the comb and prevent rearward movement of the continuous cutting blade loop.

FIG. 4D shows one exemplary embodiment of the blade tensioner used in conjunction with a comb that is curved.

FIG. 5 shows one exemplary embodiment of a blade tensioner having a tensioner pulley, a tensioner arm, and tensioner spring.

FIG. 6 shows one exemplary embodiment of gear drive transferring rotary motion from the carriage wheel of a human powered carriage to a drive guide pulley.

FIG. 7 shows a mounting of the mower head with a carriage wheel allowing cutting height adjustment of the mower head.

### DETAILED DESCRIPTION OF THE INVENTION

FIGS. 1-2 show an embodiment of the present invention, with a mowing head 10, a chassis 20, a continuous cutting blade loop 30, at least one drive guide pulley 40, at least one free wheel guide pulley 50, a blade tensioner 60, and comb 70. In this embodiment, the chassis 20 of mower head 10 is mounted to a push-type carriage 80 having two main wheels 90 and a third trailing support wheel 100, coupled to a carriage frame 110. While a three wheel carriage is depicted, this embodiment is in no way intended to limit the invention, as a variety of carriage systems could be employed including a two- or four-wheel push-type system, a self-propelled carriage using either an electric motor or internal combustion engine, or an adaptor for mounting to the bucket of a front end loader or to a three-point hitch and power takeoff on a standard farm or garden tractor, or under the frame of a garden tractor or small utility tractor. It could also be configured on an arm extending outward to the side of a tractor, as in conventional sickle-bar mowers. Multiple mower heads 10 may also be ganged in groups for large area mowing when towed in groups behind a tractor or small utility vehicle.

FIG. 3A shows the mowing head 10 in greater detail. The chassis 20 provides structural support to the mowing head 10 and mounting points for all of its components. This chassis 20 may be constructed of stamped sheet metal, cast from lightweight metal alloys or structural plastics, or welded together from individual elements to form a rigid structure. In addition to mounting points for the mower components, the chassis 20 also incorporates mounting holes and/or brackets as necessary for the intended carriage system 80. At a minimum, the chassis 20 will include attachment points for each drive guide pulley axle 45, for example with a through bearing 22, and free wheel guide pulley axle 53.

Although only two guide pulleys are shown in this embodiment, other configurations are possible and may be advantageous. A third free wheel guide pulley 51 with an axle 55 and bearing 58, as shown in FIG. 3B-3C, may be added on the inner circumference 32 of the continuous cutting blade loop 30. An integrated tension spring 52, may also be present to eliminate the need for a separate dedicated tensioner 60, and may also include a tracking adjustment 54 that changes the pitch of the free wheel guide pulley 51 to ensure the blade does not undesirably migrate toward the front or back of the pulleys 40, 50, which can cause the continuous cutting blade loop 30 to slip off or bind with other structures, such as the chassis 20, as it is fed through its transit path indicated with arrows in the FIGS. 3A, 3B and 4A The tension spring 52 and tracking adjustment 54 elements may also be added to the free wheel guide pulley 50 in lieu of adding an additional free wheel guide pulley 51.

The chassis 20 also includes mounting holes or brackets for attachment of the comb 70. The lower surface 78 of the comb 70 is ideally coincident with lines that tangentially connect the first end of the comb 70 with the drive guide pulley 40 and the second end of the comb 70 with the free wheel guide pulley 50 at their lower circumference. In such an arrangement, the inner perimeter 32 of the continuous loop blade 30 will be positioned in sliding contact with the lower surface 78 of the comb 70.

FIG. 4A illustrates the relation between the continuous cutting blade loop 30 and the comb 70 in more detail. The comb 70 has a series of comb teeth 120 dispersed along its leading edge, each adjacent comb tooth 120 being separated by a gap 130. In this illustration the gaps 130 are shown as simple vertical slots with angular perimeters, and the comb teeth 120 similarly shown as simple compound angular geometries with vertical sides. It is however understood that a wide variety of curvatures may be used in defining the perimeters of the teeth 120 and gaps 130, and that their vertical aspects through the comb 70 may include a variety of angulations ranging from a perpendicular to the lower surface 78 of the comb 70, to an acute angle bevel profile resulting in a larger gap at the top surface 79 of the comb 70 than at the bottom surface 78 of the comb 70. Further, the width of the comb teeth 120, W_{F}, and the width of the gaps 130, W_{G}, is subject to a wide range of dimensions depending on the type of plant material being mowed, for example finer grasses may use a narrower comb teeth 120, W_{F}, and narrower gaps 130, W_{G}, coarser brush may use a wider comb teeth 120, W_{F}, and broader gaps 130, W_{G}.

The continuous cutting blade loop 30 is formed from a strip of metal, for example a bimetal made of high speed steel bonded to a high-strength carbon steel base, with a series of blade teeth 140 extending radially from its leading edge. After teeth 140 have been formed on this strip of metal, the ends of the metal strip are welded together, and the weld ground to the level of the loop on its inner perimeter 32 and outer perimeter 34 to form a single smooth continuous cutting blade loop 30. If desired, more robust metals such as carbide, or other metals, can be applied to the continuous cutting blade loop teeth 140 for longer life and better shearing characteristics. As with the comb teeth 120 and comb gaps 130, the continuous cutting blade loop teeth 140 in this example are shown as simple square notches cut at regular intervals. However, tooth shape, depth, width and spacing on the blade are subject to variation, and this depiction is not intended to limit the scope of the invention in this regard. Each cutting tooth 140 however has a shear edge 36 in the direction of blade travel, indicated by arrows in FIG. 4A. The comb teeth also have a stationary shear edge 73. As the continuous cutting blade loop 30 tooth 140 shearing edge 36 moves past the comb 70 tooth 120 shearing edge 73 plant material in the gap 130 is cut.

Of particular note in FIG. 4A, is the separation of the comb teeth 120, D_{F}, relative to the separation of the continuous cutting blade loop teeth 140, D_{T}. Having the same separation in both cases, D_{F}=D_{T}, results in a situation in which all comb teeth 120 are repeatedly in the same phase of shearing at the same time as the shear edge 36 of each tooth 140 of the continuous cutting blade loop 30 moves underneath the comb 70. This situation may cause an uneven cyclic load on the external power source driving the continuous cutting blade loop 30 causing it to stall or bog down. In this case, the relative separation is selected to create a ratio of D_{F}/D_{T} in the range of 0.5 to 1, thus staggering the point in the shear cycle at each comb tooth 120 as the continuous cutting blade loop 30 slides along the comb 70. As a result, a lower, more continuous driving force is needed circulate the continuous cutting blade loop 30 through its course under the comb 70 and around the free wheel guide pulleys 50 and drive guide pulley 40, as not all continuous cutting blade loop teeth 140 are shearing at the same time.

As depicted in FIG. 4A, the comb 70 may be constructed with a slot 75 running its entire length along its leading edge to retain the continuous cutting blade loop 30 in close proximity to the comb lower surface 78. This may be accomplished by machining the slot to a depth approximately equal to the width of the continuous cutting blade loop 30, and width slightly greater than the thickness of the continuous cutting blade loop 30.

Alternatively, as shown in FIG. 4B, the comb 70 may be formed as an upper half 72 and lower half 74, one or both halves being machined to form a slot 75 of appropriate dimensions when the two halves 72.74 are mechanically joined with screws, bolts, or other fasteners. In yet another embodiment, as shown in FIG. 4C, the comb may be flat along its lower surface 78, with retaining wheels 76 at its trailing edge providing both resistance to rearward motion of the continuous cutting blade loop 30, and upward force to maintain the continuous cutting blade loop 30 in contact with the lower surface 78 of the comb 70.

In another embodiment, as shown in FIG. 4D, the comb 70 may have a convex curved profile from its first end to its second end, thus forcing the continuous cutting blade loop 30 against its lower surface 78 at all points, with wear between the lower surface 78 of the comb 70 and the continuous cutting blade loop 30 inner circumference 32 resulting in a self sharpening action on their respective shearing edges 73, 36.

To facilitate easy removal, the continuous loop blade 30 is constructed to be slightly longer than the pathway it traverses around the free wheel guide pulley 50, drive guide pulley 40, and comb 70. The slack created due to the additional length is adjusted by a spring loaded tensioner 60 and tensioner pulley 150. The tensioner 60 is fitted with a spring 160 that forces the tensioner pulley 150 in rotational contact with the continuous cutting blade loop 30, removing slack and providing sufficient frictional force between the continuous cutting blade loop 30 inner diameter 32 and drive guide pulley 40 to move the continuous cutting blade loop 30 throughout its travel path on the mowing head 10 without slippage during cutting operations.

In the embodiment shown in FIG. 5, the tensioner wheel 150 is attached to a tensioner 60 having a spring mechanism 160, thus applying pressure to the outer perimeter 34 of the continuous cutting blade loop 30. However, it is understood that a variety of tensioners 60 are possible. One configuration includes a tensioner 60 and tensioner wheel 150 on the inner perimeter 32 of the continuous cutting blade loop 30, pressing outward from its travel pathway. Also, as previously shown in FIG. 3B, an additional free wheel guide pulley 51 may be configured with an axle 55 slidably mounted on the chassis 20 with a linear spring 52 forcing the free wheel guide pulley 51 to the outside of the continuous cutting blade loop 30 travel path.

Referring now to FIG. 6, motive power can be provided to the axel 45 of the drive guide pulley 40 through a gear system 170 connected to one of the carriage wheels 90. A bevel gear 190 is attached to the hub of the carriage wheel 90 in one plane, and a miter gear 180 is attached to the axle 45 of the drive guide pulley 40 in an orthogonal plane. Thus, when the carriage 80 is pushed forward, rotary motion of the wheel 90 is transferred to the drive guide pulley 40, causing the continuous cutting blade loop 30 to move in continuous sliding contact in one direction along the lower surface 78 of the comb 70.

In this embodiment, bevel gear 190 is connected to the carriage wheel 90 using a ratchet mechanism, or one-way bearing system known in the art, to only cause the carriage wheel 90 to drive the bevel gear 190 when the carriage 80 is in forward motion. Alternatively, the bevel 190 gear may be fixed to the carriage wheel 90, and a ratchet or one way bearing integrated in the miter gear 180 attachment to the drive guide pulley axle 45. In this manner the angular momentum of the drive and guide pulleys can be allowed to carry the continuous cutting blade loop 30 in its direction of motion when the carriage 80 is pulled backward, or when carriage 80 forward motion is not present. To enhance this effect, a massive flywheel 56, as shown in FIG. 3C, may be added to one or more of the drive guide pulleys 40 and/or one or more of the free wheel guide pulleys 50.

In an alternative embodiment, motive power to the drive guide pulley 40 may be provided by an electric motor, or internal combustion engine, either directly coupled to the drive guide pulley axle 45, or mechanically coupled through a gearing system, belt drive, or chain drive connected to its axle 45.

Referring now to FIG. 7, to facilitate adjustments for various cutting heights, the mower head 10 may connected to the carriage 80 using a mount 200. The mount is constructed to pivot about the same axis of rotation as the carriage wheel 90, and the bevel gear 190. As a result, the orientation of the drive guide pulley 40 axle 45 is always along a radius extending from that axis, so that operational contact is maintained between the bevel gear 190 and the miter gear 180 regardless of the position of the mount 200. This configuration makes it possible to raise the mower head 10 to various positions above the ground, for example from H1 to H2, without losing power delivered from the carriage wheel 190.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A mower head comprising:
a) a chassis having a width between a first side and a second side;
b) a comb mounted across the width of the chassis, having a first end toward the first side of the chassis, a second end toward the second end of the chassis, a lower surface, and a leading edge having a plurality of comb teeth spaced apart at intervals, the comb teeth intersecting with the lower surface of the comb at a shearing edge;
c) at least one drive guide pulley mounted adjacent to the first side of the chassis, having an outer circumference and an axle having a first end fixed to the drive guide pulley at a rotational center and a second end;
d) at least one free wheel guide pulley mounted adjacent to the second side of the chassis, having a rotational center, an outer circumference, and an axle having a first end and second end, where the first end mates with a bearing at the rotational center of the free wheel guide pulley allowing the free wheel pulley to freely rotate;
e) a continuous cutting blade loop comprising a leading edge having a plurality of shearing teeth at intervals, a length of the cutting blade loop being at least sufficient to loop over the at least one drive guide pulley and the at least one free wheel guide pulley and across the comb; and
f) a rotating power source coupled to the second end of the axle of the at least one drive guide pulley; the rotating power source rotating the drive guide pulley to cause the continuous cutting blade loop to slide longitudinally along the comb.

2. The mower head of claim 1 in which the rotational power source is an output shaft of an electric motor.

3. The mower head of claim 1 in which the rotational power source is an output shaft of an internal combustion engine.

4. The mower head of claim 1, in which the chassis further comprises at least one supporting wheel, and the rotational power source is coupled to the at least one supporting wheel.

5. The mower head of claim 4, in which the rotational power source further comprises a gear attached to the second end of the drive guide pulley axle, engaging a gear on the supporting wheel.

6. The mower head of claim 5, further comprising a bracket having a first end and a second end, the bracket first end fixed to the chassis at a point of mounting the drive guide pulley, and the second end of the bracket having a pivot point coincident with an axis of rotation of the at least one supporting wheel, the drive guide pulley axle running parallel to the bracket, such that as the bracket pivots on the pivot point, the gear on the drive guide pulley axle remains engaged with the gear on the supporting wheel.

7. The mower head of claim 1 where the intervals between the teeth of the comb are not equal to the intervals between shearing teeth of the continuous cutting blade loop.

8. The mower head of claim 1 where the continuous cutting blade loop is formed from a strip of flexible metal having a first end and second end butt welded together to form a continuous loop.

9. The mower head of claim 1 where the cutting blade loop is made of a bimetal.

10. The mower head of claim 1 where at least a portion of each of the shearing teeth of the cutting blade loop is reinforced with a harder substance.

11. The mower head of claim 1 where the outer circumference of the at least one drive guide pulley and the outer circumference of the at least one free wheel guide pulley have a rubber surface having a high coefficient of rolling friction relative to the continuous cutting blade loop.

12. The mower head of claim 1 where the comb has a curvature forming an arc from its first end to its second end.

13. The mower head of claim 1 further comprising a flywheel coupled to at least one free wheel guide pulley.

14. The mower head of claim 1 further comprising a flywheel coupled to at least one drive guide pulley.

15. The mower head of claim 1 where the axle of the at least one free wheel guide pulley is adjustably mounted to the chassis.

16. The mower head of claim 1 further comprising a tensioner having a tensioner pulley and spring, said spring forcing the tensioner pulley against the continuous cutting blade loop.

17. The mower head of claim 1 in which the continuous cutting blade slides along the lower surface of the comb.

18. The mower head of claim 1 in which the continuous cutting blade loop slides through a slot in the leading edge of the comb parallel to the lower surface of the comb.

19. The mower head of claim 1 in which a plurality of rotating disks are mounted on the lower surface of the comb at the trailing edge of the comb holding the continuous cutting blade loop in contact with the lower surface of the comb.
